(19) United States
(12) Patent Application Publication
(10) Pub. No.: US 2026/0143069 A1
(43) Pub. Date: May 21, 2026

(54) DEVICE MANAGEMENT SYSTEM AND DEVICE MANAGEMENT PROGRAM

(71) Applicant: KYOCERA DOCUMENT SOLUTIONS INC., OSAKA (JP)

(72) Inventor: HIROKAZU MIYANISHI, OSAKA (JP)

(21) Appl. No.: 19/312,311

(22) Filed: Aug. 28, 2025

(30) Foreign Application Priority Data
Aug. 29, 2024 (JP) 2024-147968

(51) Int. Cl. H04N 1/00

(52) U.S. Cl. CPC H04N 1/00079; H04N 1/00029; H04N 2201/0094

(57) ABSTRACT

A device management system includes a device management unit that manages a device. The device management unit executes a warning of a sign of a failure in the device. The device management unit sends a warning mail that is an e-mail for notifying of the warning in a case where the device management unit executes the warning.

### CROSS-REFERENCE TO RELATED PATENT APPLICATION

This application claims the benefit of Japanese Priority Patent Application JP 2024-147968 filed Aug. 29, 2024, the entire contents of which are incorporated herein by reference.

### FIELD OF THE DISCLOSURE

The present disclosure relates to a device management system and a device management program that manage a device.

### BACKGROUND OF THE DISCLOSURE

As a device management system in related art, one that predicts the occurrence of a failure in an image forming apparatus that is a device on the basis of information regarding a jam where a recording medium is jammed in the image forming apparatus and sends a prediction result to a terminal apparatus installed at a service base that controls the target image forming apparatus is known (e.g., see Japanese Patent Application Laid-open No. HEI 9-50156, Japanese Patent Application Laid-open No. HEI 9-321931).

### SUMMARY OF THE DISCLOSURE

A device management system according to the present disclosure includes a device management unit that manages a device. The device management unit executes a warning of a sign of a failure in the device. The device management unit sends a warning mail that is an e-mail for notifying of the warning in a case where the device management unit executes the warning.

A device management program according to the present disclosure causes a computer to operate as a device management unit that manages a device. The device management unit executes a warning of a sign of a failure in the device. The device management unit sends a warning mail that is an e-mail for notifying of the warning in a case where the device management unit executes the warning.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 is a block diagram of an example of a system according to an embodiment of the present disclosure.

FIG. 2 is a block diagram of an example of an image forming apparatus shown in FIG. 1 in a case where it is constituted by an MFP.

FIG. 3 is a block diagram of an example of a device management system shown in FIG. 1 in a case where it is constituted by a single computer.

FIG. 4 is a diagram showing an example of tenant management information shown in FIG. 3.

FIG. 5 is a diagram showing an example of user management information shown in FIG. 3.

FIG. 6 is a diagram showing an example of device management information shown in FIG. 3.

FIG. 7 is a diagram showing an example of jam management information shown in FIG. 3.

FIG. 8 is a block diagram of an example of a user terminal shown in FIG. 1.

FIG. 9 is a sequence diagram of an operation of the system shown in FIG. 1 in a case where the image forming apparatus is registered in the device management system.

FIG. 10 is a sequence diagram of an operation of the system shown in FIG. 1 in a case where jam information of the image forming apparatus is stored in the device management system.

FIG. 11 is a flowchart of an operation of the device management system shown in FIG. 3 in a case of executing processing related to a failure sign warning.

FIG. 12 is a flowchart of an example of warning generation processing shown in FIG. 11.

FIG. 13 is a flowchart of an example of short-term jam determination processing shown in FIG. 12.

FIG. 14 is a flowchart of an example of long-term jam determination processing shown in FIG. 12.

FIG. 15 is a flowchart of an example of warning target location determination case processing shown in FIG. 12.

FIG. 16 is a flowchart of an example of warning mail sending processing shown in FIG. 15.

FIG. 17 is a diagram showing an example of the body of a warning mail sent in the warning mail sending processing shown in FIG. 16.

FIG. 18 is a sequence diagram of an operation of the system shown in FIG. 1 in a case where a user of the device management system checks the failure sign warning.

FIG. 19 is a diagram showing an example of a device list page displayed in the operation shown in FIG. 18.

FIG. 20 is a diagram showing an example of a jam history page displayed in the operation shown in FIG. 18.

### DETAILED DESCRIPTION OF THE EXEMPLARY EMBODIMENTS

Hereinafter, an embodiment of the present disclosure will be described with reference to the drawings.

First of all, a configuration of the system according to the embodiment of the present disclosure will be described.

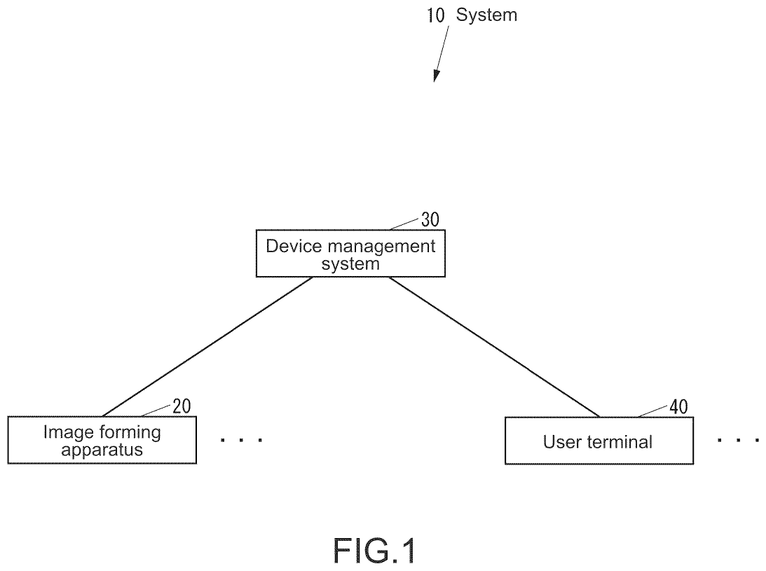

FIG. 1 is a block diagram of an example of a system 10 according to the present embodiment.

As shown in FIG. 1, the system 10 includes an image forming apparatus 20 that forms an image. The system 10 may include at least one image forming apparatus with a configuration similar to that of the image forming apparatus 20 in addition to the image forming apparatus 20. For example, the image forming apparatus may be constituted by a dedicated printer or may be constituted by a multifunction peripheral (MFP).

The system 10 includes a device management system 30 that manages image forming apparatuses. The device management system 30 may be constituted by a single computer, such as a personal computer (PC), or may be constituted by multiple computers. The device management system 30 may be constituted on the local area network (LAN) as the image forming apparatus or may be configured on a cloud.

The system 10 includes a user terminal 40 that is used by a user of the device management system 30. The system 10 may include at least one user terminal with a configuration similar to that of the user terminal 40 in addition to the user terminal 40. The user terminal may be constituted by a computer, such as a PC.

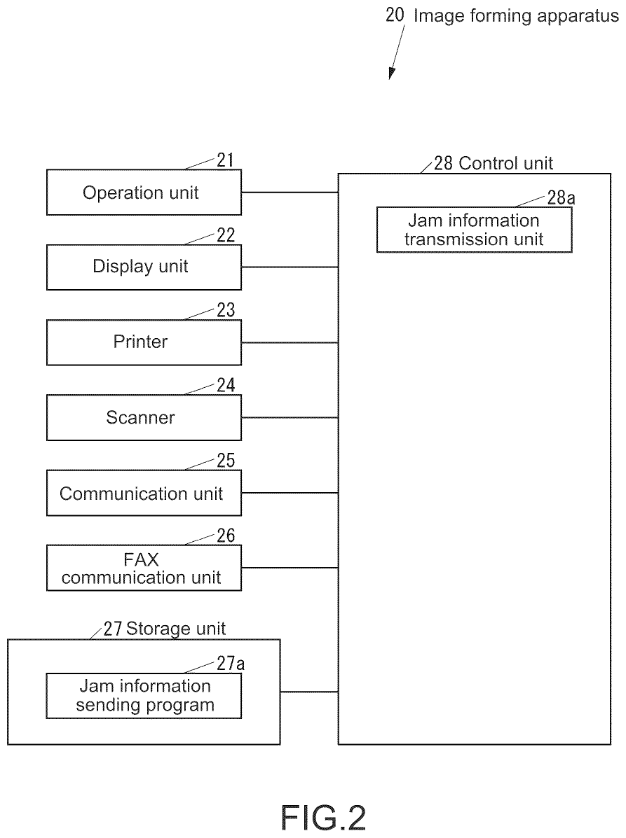

FIG. 2 is a block diagram of an example of the image forming apparatus 20 in a case where it is constituted by an MFP.

As shown in FIG. 2, the image forming apparatus 20 is a computer including an operation unit 21, a display unit 22, a printer 23, a scanner 24, a communication unit 25, a fax communication unit 26, a storage unit 27, and a control unit 28. The operation unit 21 is an operation device to which various operations are input, such as buttons. The display unit 22 is a display device that displays various types of information, such as a liquid crystal display (LCD). The printer 23 is a printer device that prints an image on a recording medium such as paper. The scanner 24 is a reading device that reads an image from an original document. The communication unit 25 is a communication device that communicates with an external apparatus via a network, such as a LAN or Internet, or directly with a wire or wirelessly without the network. The fax communication unit 26 is a fax device that performs fax communication with an external facsimile apparatus (not shown) via a telecommunication line, such as a public telephone line. The storage unit 27 is a nonvolatile storage device that stores various types of information, such as a semiconductor memory or a hard disk drive (HDD). The control unit 28 comprehensively controls the image forming apparatus 20.

The storage unit 27 is capable of storing a jam information sending program 27a. The jam information sending program 27a is for sending information regarding a jam where a recording medium is jammed in the image forming apparatus 20 (hereinafter, referred to as “jam information”) to the device management system 30 (see FIG. 1). For example, the jam information sending program 27a may be installed in the image forming apparatus 20 during the production phase of the image forming apparatus 20. Alternatively, for example, the jam information sending program 27a may be additionally installed in the image forming apparatus 20 from an external storage medium, such as a universal serial bus (USB) memory. Alternatively, for example, the jam information sending program 27a may be additionally installed in the image forming apparatus 20 from a network.

For example, the control unit 28 includes a central processing unit (CPU), a read only memory (ROM) that stores programs and various data, and a random access memory (RAM) that serves as a memory used as a working area for the CPU of the control unit 28. The CPU of the control unit 28 executes the programs stored in the storage unit 27 or the ROM of the control unit 28.

The control unit 28 realizes a jam information transmission unit 28a that sends the jam information to the device management system 30 by executing the jam information sending program 27a.

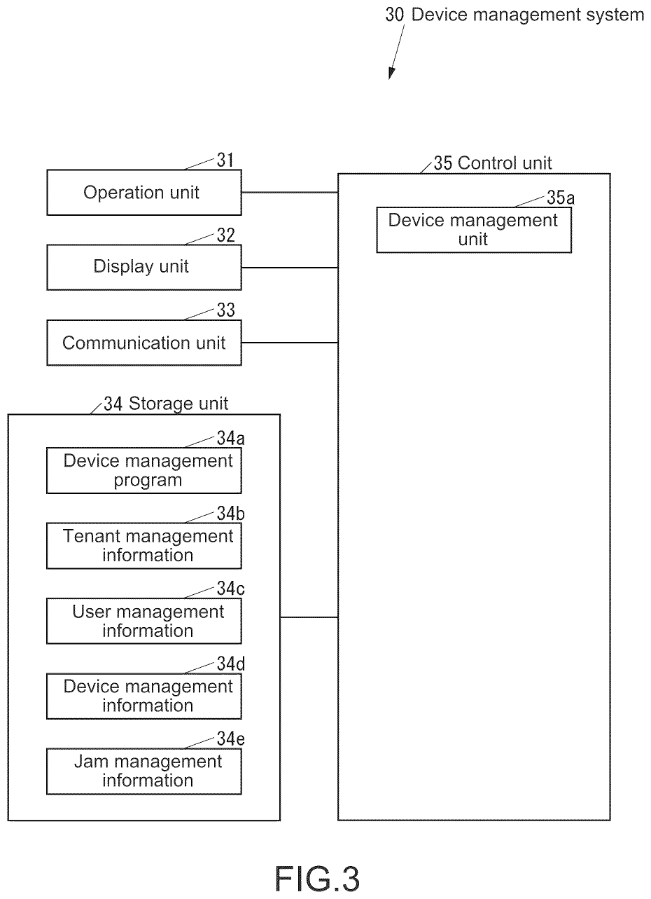

FIG. 3 is a block diagram of an example of the device management system 30 in a case where it is constituted by a single computer.

As shown in FIG. 3, the device management system 30 includes an operation unit 31, a display unit 32, a communication unit 33, a storage unit 34, and a control unit 35. The operation unit 31 is an operation device to which various operations are input, such as keyboard and mouse. The display unit 32 is a display device that displays various types of information, such as an LCD. The communication unit 33 is a communication device that communicates with an external apparatus via a network, such as a LAN or Internet, or directly with a wire or wirelessly without the network. The storage unit 34 is a nonvolatile storage device that stores various types of information, such as a semiconductor memory or an HDD. The control unit 35 comprehensively controls the device management system 30.

The storage unit 34 is capable of storing a device management program 34a. The device management program 34a is for managing image forming apparatuses. For example, the device management program 34a may be installed in the device management system 30 during the production phase of the device management system 30. Alternatively, for example, the device management program 34a may be additionally installed in the device management system 30 from an external storage medium, such as a USB memory. Alternatively, for example, the device management program 34a may be additionally installed in the device management system 30 from a network.

The storage unit 34 is capable of storing tenant management information 34b. The tenant management information 34b is for managing tenants of the device management system 30.

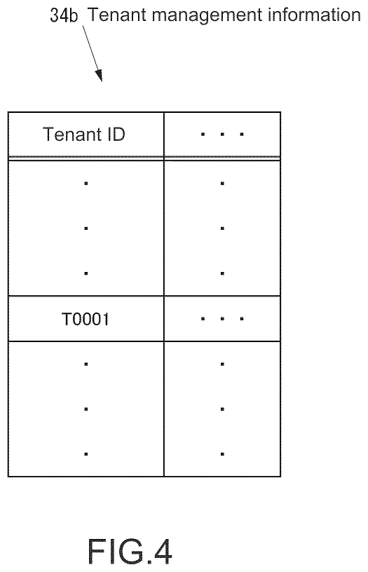

FIG. 4 is a diagram showing an example of the tenant management information 34b.

As shown in FIG. 4, the tenant management information 34b includes, for each tenant, a tenant ID that is identification information of the tenant. The tenant management information 34b shown in FIG. 4 is depicted with some information omitted.

As shown in FIG. 3, the storage unit 34 is capable of storing user management information 34c. The user management information 34c is for managing users of the device management system 30.

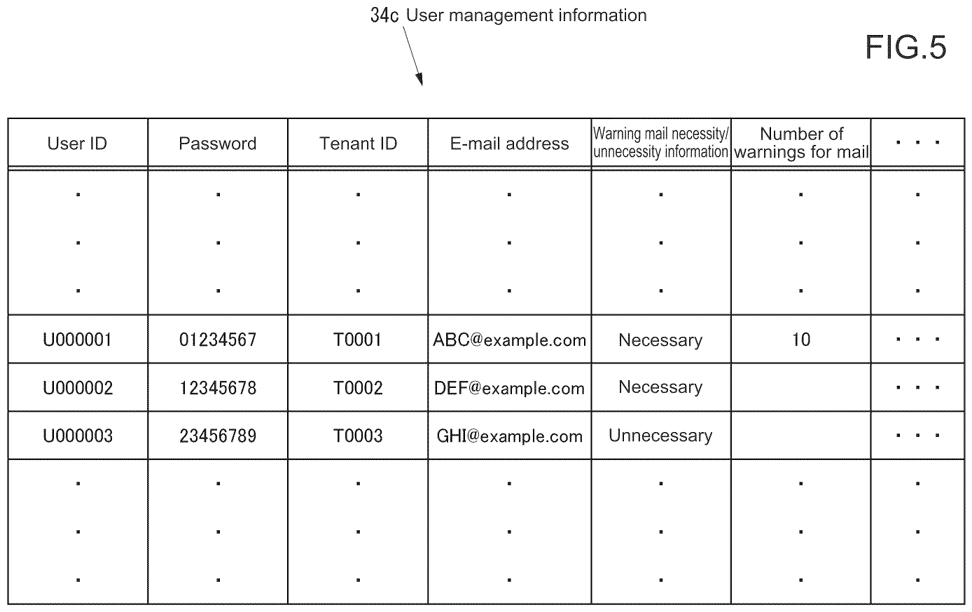

FIG. 5 is a diagram showing an example of the user management information 34c.

As shown in FIG. 5, the user management information 34c includes, for each user, a user ID that is identification information of the user, a password of the user, a tenant ID of a tenant managed by the user, an e-mail address of the user, information indicating whether or not sending of an e-mail (hereinafter, referred to as “warning mail”) for notifying a warning of a sign of a failure (hereinafter, referred to as “failure sign warning”) in the image forming apparatus is necessary (hereinafter, referred to as “warning mail necessity/unnecessity information”), and the number of times of generation of failure sign warnings in a case of sending the warning mail (hereinafter, referred to as “number of warnings for mail”). The user management information 34c shown in FIG. 5 is depicted with some information omitted.

The e-mail address of the user, the warning mail necessity/unnecessity information, and the number of warnings for mail in the user management information 34c can be set in accordance with an instruction input via the operation unit 31 or the communication unit 33 of the device management system 30, for example.

As shown in FIG. 3, the storage unit 34 is capable of storing device management information 34d. The device management information 34d is for managing information of the image forming apparatus.

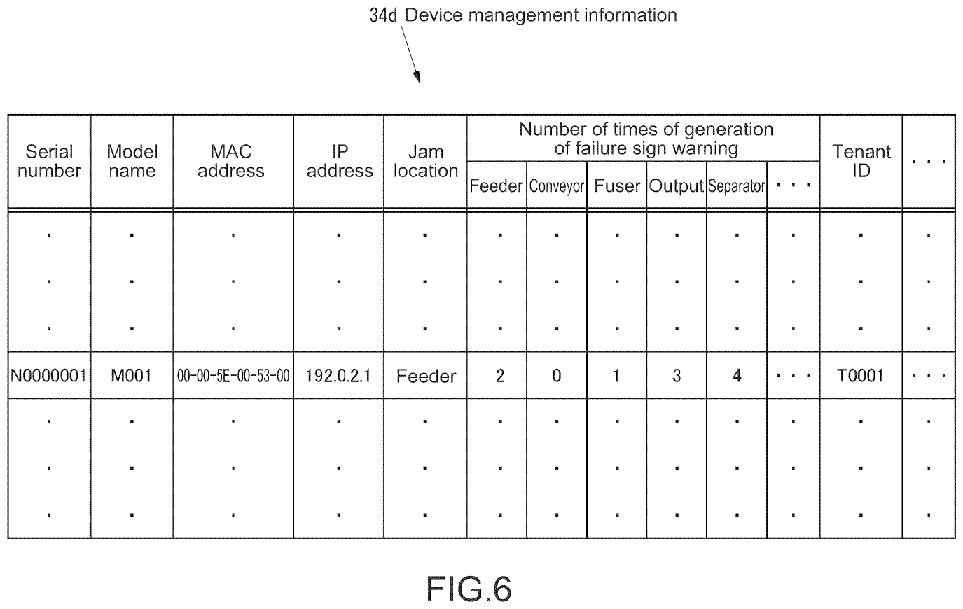

FIG. 6 is a diagram showing an example of the device management information 34d.

As shown in FIG. 6, the device management information 34d includes, for each image forming apparatus, a serial number that is identification information of the image forming apparatus, a model name of the image forming apparatus, a media access control (MAC) address of the image forming apparatus, an internet protocol (IP) address of the image forming apparatus, an occurrence location of a jam that is a failure sign warning target (hereinafter, the occurrence location of the jam will be simply referred to as “jam location”), the number of times of generation of failure sign warnings for each jam location, and a tenant ID of the tenant to which the image forming apparatus belongs. As the jam location, for example, there are a feeder for feeding the recording medium, a conveyor for conveying the recording medium, a fuser for fusing toner transferred onto the recording medium, an output for outputting the recording medium, and a separator for sorting recording media to a plurality of outputs. The device management information 34d shown in FIG. 6 is depicted with some information omitted.

As shown in FIG. 3, the storage unit 34 is capable of storing jam management information 34e. The jam management information 34e is for managing the jam information.

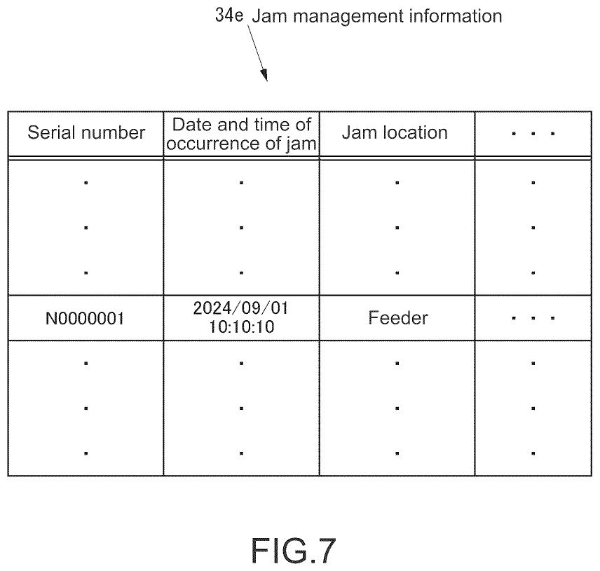

FIG. 7 is a diagram showing an example of the jam management information 34e.

As shown in FIG. 7, the jam management information 34e includes, for each piece of jam information, a serial number of an image forming apparatus to be indicated by the jam information, date and time of occurrence of the jam to be indicated by the jam information, and a jam location of the jam to be indicated by the jam information in the image forming apparatus to be indicated by the jam information. The jam management information 34e shown in FIG. 7 is depicted with some information omitted.

For example, the control unit 35 shown in FIG. 3 includes a central processing unit (CPU), a read only memory (ROM) that stores programs and various data, and a random access memory (RAM) that serves as a memory used as a working area for the CPU of the control unit 35. The CPU of the control unit 35 executes the programs stored in the storage unit 34 or the ROM of the control unit 35.

The control unit 35 realizes a device management unit 35a that manages the image forming apparatuses by executing the device management program 34a.

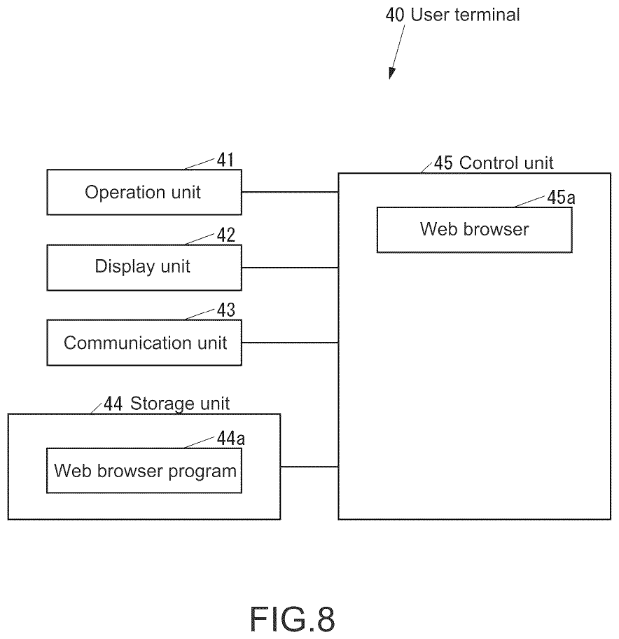

FIG. 8 is a block diagram of an example of the user terminal 40.

As shown in FIG. 8, the user terminal 40 includes an operation unit 41, a display unit 42, a communication unit 43, a storage unit 44, and a control unit 45. The operation unit 41 is an operation device to which various operations are input, such as keyboard and mouse. The display unit 42 is a display device that displays various types of information, such as an LCD. The communication unit 43 is a communication device that communicates with an external apparatus via a network, such as a LAN or Internet, or directly with a wire or wirelessly without the network. The storage unit 44 is a nonvolatile storage device that stores various types of information, such as a semiconductor memory or an HDD. The control unit 45 comprehensively controls the user terminal 40.

The storage unit 44 is capable of storing a web browser program 44a that is a program for a web browser. For example, the web browser program 44a may be installed in the user terminal 40 during the production phase of the user terminal 40. Alternatively, for example, the web browser program 44a may be additionally installed in the user terminal 40 from an external storage medium, such as a USB memory. Alternatively, for example, the web browser program 44a may be additionally installed in the user terminal 40 from a network.

For example, the control unit 45 includes a central processing unit (CPU), a read only memory (ROM) that stores programs and various data, and a random access memory (RAM) that serves as a memory used as a working area for the CPU of the control unit 45. The CPU of the control unit 45 executes the programs stored in the storage unit 44 or the ROM of the control unit 45.

The control unit 45 realizes a web browser 45a by executing the web browser program 44a.

Next, an operation of the system 10 will be described.

Hereinafter, the image forming apparatus 20 will be described, representing the image forming apparatus. Similarly, the user terminal 40 will be described, representing the user terminal.

First of all, an operation of the system 10 in a case where the image forming apparatus 20 is registered in the device management system 30 will be described.

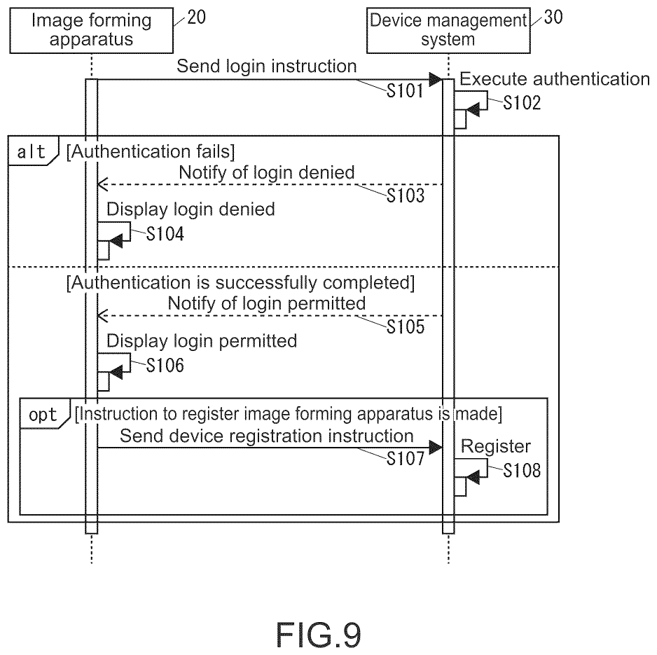

FIG. 9 is a sequence diagram of the operation of the system 10 in a case where the image forming apparatus 20 is registered in the device management system 30.

The user of the device management system 30 is capable of instructing the image forming apparatus 20 to log into the device management system 30 via the operation unit 21 of the image forming apparatus 20. When the jam information transmission unit 28a of the image forming apparatus 20 is instructed to log into the device management system 30 is made, as shown in FIG. 9, the jam information transmission unit 28a of the image forming apparatus 20 sends the instruction to log into the device management system 30 (hereinafter, referred to as “login instruction”) to the device management system 30 (S101). The jam information transmission unit 28a includes the user ID and the password of the user, which have been input via the operation unit 21, in the login instruction in S101.

When the device management unit 35a of the device management system 30 receives the login instruction sent by the image forming apparatus 20 in S101, the device management unit 35a of the device management system 30 executes user authentication on the basis of the combination of the user ID and the password included in the received login instruction (S102). In a case where the combination of the user ID and the password included in the login instruction is included in the user management information 34c, the device management unit 35a determines that the user authentication has been successfully completed. On the other hand, in a case where the combination of the user ID and the password included in the login instruction is not included in the user management information 34c, the device management unit 35a determines that the user authentication has failed.

When the device management unit 35a determines that the authentication executed in S102 has failed, the device management unit 35a notifies the image forming apparatus 20 of the user's login denied (S103).

When the jam information transmission unit 28a of the image forming apparatus 20 is notified of the user's login denied from the device management system 30 in S103, the jam information transmission unit 28a of the image forming apparatus 20 displays the user's login denied on the display unit 22 (S104).

When the device management unit 35a of the device management system 30 determines that the authentication executed in S102 has been successfully completed, the device management unit 35a of the device management system 30 notifies the image forming apparatus 20 of the user's login permitted (S105).

When the jam information transmission unit 28a of the image forming apparatus 20 is notified of the user's login permitted from the device management system 30 in S105, the jam information transmission unit 28a of the image forming apparatus 20 displays the user's login permitted on the display unit 22 (S106).

In a case where the user of the device management system 30 has logged into the device management system 30, the user of the device management system 30 is capable of instructing the image forming apparatus 20 to register the image forming apparatus 20 in the device management system 30 via the operation unit 21 of the image forming apparatus 20. When the jam information transmission unit 28a of the image forming apparatus 20 is instructed to register the image forming apparatus 20 in the device management system 30, as shown in FIG. 9, the jam information transmission unit 28a of the image forming apparatus 20 sends an instruction to register the image forming apparatus 20 (hereinafter, referred to as “device registration instruction”) to the device management system 30 (S107). The jam information transmission unit 28a includes the serial number, the model name, the MAC address, and the IP address of the image forming apparatus 20 in the device registration instruction in S107.

When the device management unit 35a of the device management system 30 receives the device registration instruction sent by the image forming apparatus 20 in S107, the device management unit 35a of the device management system 30 registers the combination of the serial number, the model name, the MAC address, and the IP address included in the received device registration instruction in the device management information 34d in association with the tenant ID associated with the user ID of the user who has logged in via the image forming apparatus 20 in the user management information 34c (S108).

Hereinabove, the case where the image forming apparatus 20 is registered in the device management system 30 by the user of the device management system 30 operating the image forming apparatus 20 via the operation unit 21 of the image forming apparatus 20 has been described. Here, the image forming apparatus 20 is capable of providing a webpage (hereinafter, referred to as “device operation page”) that allows operations on the image forming apparatus 20. In a case where the image forming apparatus 20 provides the device operation page, the user of the device management system 30, for example, accesses the device operation page via the user terminal 40, and then operates the image forming apparatus 20 via the device operation page, thereby being capable of registering the image forming apparatus 20 in the device management system 30 as in the operation shown in FIG. 9.

Next, an operation of the system 10 in a case where the jam information of the image forming apparatus 20 is stored in the device management system 30 will be described.

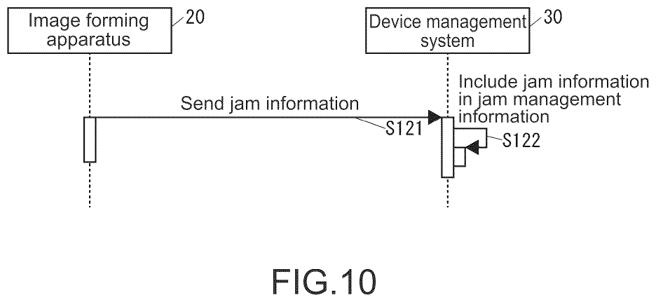

FIG. 10 is a sequence diagram of the operation of the system 10 in a case where the jam information of the image forming apparatus 20 is stored in the device management system 30.

When a jam occurs in the image forming apparatus 20, as shown in FIG. 10, the jam information transmission unit 28a of the image forming apparatus 20 sends jam information regarding this jam to the device management system 30 (S121). The jam information transmission unit 28a includes the serial number of the image forming apparatus 20, the date and time of occurrence of the jam to be indicated by the jam information in S121, and the jam location of the jam to be indicated by the jam information in S121 in the image forming apparatus 20 in the jam information in S121.

When the device management unit 35a of the device management system 30 receives the jam information sent by the image forming apparatus 20 in S121, the device management unit 35a of the device management system 30 includes the received jam information in the jam management information 34e (S122).

Next, an operation of the device management system 30 in a case of executing processing related to the failure sign warning will be described.

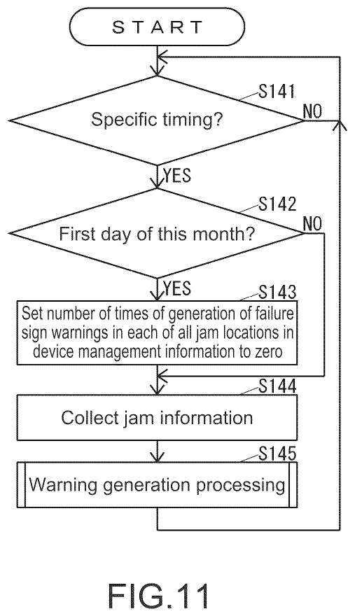

FIG. 11 is a flowchart of the operation of the device management system 30 in a case of executing the processing related to the failure sign warning.

As shown in FIG. 11, the device management unit 35a of the device management system 30 determines whether or not the current time is a specific timing until the device management unit 35a of the device management system 30 determines that the current time is the specific timing (S141). For example, the specific timing may be a specific point of time on each day, such as 9:00 AM on each day.

When the device management unit 35a determines in S141 that the current time is the specific timing, the device management unit 35a determines whether or not the current time is the first day of this month (S142).

When the device management unit 35a determines in S142 that the current time is the first day of this month, the device management unit 35a sets the number of times of generation of failure sign warnings in each of all jam locations, which has been associated with the serial number of the image forming apparatus 20 in the device management information 34d, to zero (S143).

When the device management unit 35a determines in S142 that the current time is not the first day of this month or when the processing of S143 ends, the device management unit 35a collects the jam information of the image forming apparatus 20 up to the previous day from the jam management information 34e (S144).

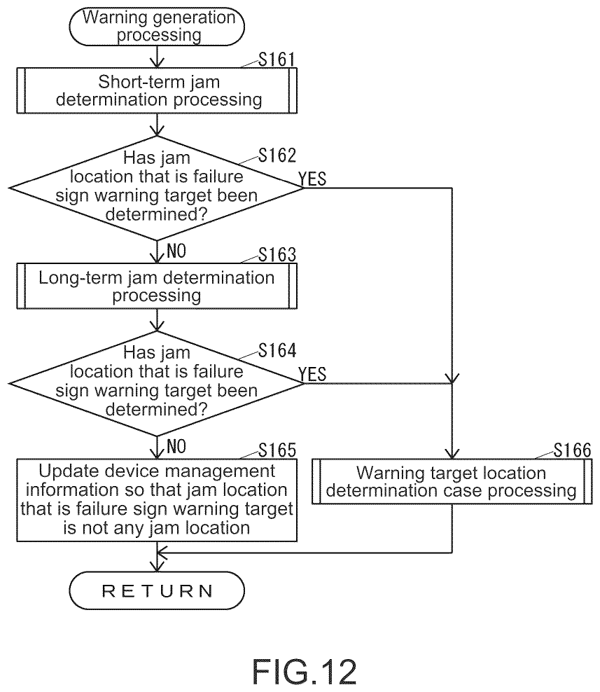

When the processing of S144 ends, the device management unit 35a executes warning generation processing (see FIG. 12) that is processing of generating a failure sign warning (S145).

FIG. 12 is a flowchart of an example of the warning generation processing shown in FIG. 11.

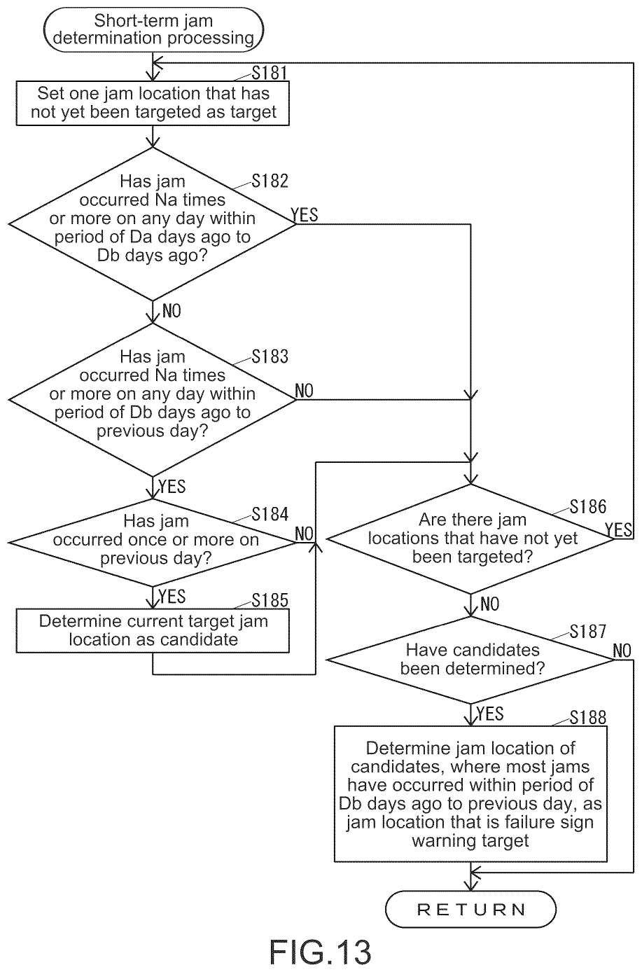

As shown in FIG. 12, the device management unit 35a executes short-term jam determination processing (see FIG. 13) that is processing of determining whether or not to generate a failure sign warning on the basis of a status of occurrence of the jam in a short period (S161).

FIG. 13 is a flowchart of an example of the short-term jam determination processing shown in FIG. 12.

As shown in FIG. 13, the device management unit 35a sets only one jam location of specific jam locations, which has not yet been targeted in this short-term jam determination processing, as a target (S181).

The device management unit 35a determines whether or not a jam has occurred Na times or more in the current target jam location on any day within the period of Da days ago to Db days ago on the basis of the jam information collected in S144 (S182). For example, Na, Da, Db may be 5, 28, 7, respectively.

When the device management unit 35a determines in S182 that a jam has not occurred Na times or more in the current target jam location on any day within the period of Da days ago to Db days ago, the device management unit 35a determines whether or not a jam has occurred Na times or more in the current target jam location on any day within the period of Db days ago to 1 day ago, i.e., the previous day, on the basis of the jam information collected in S144 (S183).

When the device management unit 35a determines in S183 that a jam has occurred Na times or more in the current target jam location on any day within the period of Db days ago to the previous day, the device management unit 35a determines whether or not a jam has occurred once or more in the current target jam location on the previous day on the basis of the jam information collected in S144 (S184).

When the device management unit 35a determines in S184 that a jam has occurred once or more in the current target jam location on the previous day, the device management unit 35a determines the current target jam location as a jam location candidate that is a failure sign warning target (S185).

When the device management unit 35a determines in S182 that a jam has occurred Na times or more in the current target jam location on any day within the period of Da days ago to Db days ago, when the device management unit 35a determines in S183 that a jam has not occurred Na times or more in the current target jam location on any day within the period of Db days ago to the previous day, when the device management unit 35a determines in S184 that the jam has not occurred once or more in the current target jam location on the previous day, or when the processing of S185 ends, the device management unit 35a determines whether or not there are jam locations of the specific jam locations, which have not yet been targeted in this short-term jam determination processing (S186).

When the device management unit 35a determines in S186 that there are jam locations of the specific jam locations, which have not yet been targeted in this short-term jam determination processing, the device management unit 35a executes the processing of S181.

When the device management unit 35a determines in S186 that there are no jam locations of the specific jam locations, which have not yet been targeted in this short-term jam determination processing, the device management unit 35a determines whether or not the device management unit 35a has determined jam location candidates that are failure sign warning targets in this short-term jam determination processing (S187).

When the device management unit 35a determines in S187 that the device management unit 35a has determined jam location candidates that are failure sign warning targets in this short-term jam determination processing, the device management unit 35a determines a jam location of jam location candidates that are failure sign warning targets that have been determined in this short-term jam determination processing, where the most jams have occurred within the period of Db days ago to the previous day, as a jam location that is a failure sign warning target (S188).

When the device management unit 35a determines in S187 that the device management unit 35a has not determined jam location candidates that are failure sign warning targets in this short-term jam determination processing or when the processing of S188 ends, the device management unit 35a terminates the short-term jam determination processing shown in FIG. 13.

As shown in FIG. 12, when the short-term jam determination processing of S161 ends, the device management unit 35a determines whether or not the device management unit 35a has determined a jam location that is a failure sign warning target in the short-term jam determination processing of S161 (S162).

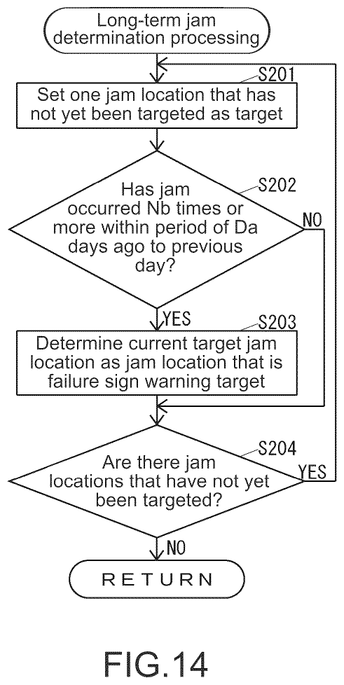

When the device management unit 35a determines in S162 that the device management unit 35a has not determined a jam location that is a failure sign warning target in the short-term jam determination processing of S161, the device management unit 35a executes the long-term jam determination processing (see FIG. 14) that is processing of determining whether or not to generate a failure sign warning on the basis of a status of occurrence of the jam in a long period (S163).

FIG. 14 is a flowchart of an example of the long-term jam determination processing shown in FIG. 12.

As shown in FIG. 14, the device management unit 35a sets only one jam location of the specific jam locations, which has not yet been targeted in this long-term jam determination processing, as a target (S201).

When the processing of S201 ends, the device management unit 35a determines whether or not the jam has occurred Nb times or more in the current target jam location within the period of Da days ago to the previous day on the basis of the jam information collected in S144 (S202). For example, Nb may be 45.

When the device management unit 35a determines in S202 that the jam has occurred Nb times or more in the current target jam location within the period of Da days ago to the previous day, the device management unit 35a determines the current target jam location as a jam location that is a failure sign warning target (S203).

When the device management unit 35a determines in S202 that the jam has not occurred Nb times or more in the current target jam location within the period of Da days ago to the previous day or when the processing of S203 ends, the device management unit 35a determines whether or not there are jam locations of specific jam locations, which have not yet been targeted in this long-term jam determination processing (S204).

When the device management unit 35a determines in S204 that there are jam locations of specific jam locations, which have not yet been targeted in this long-term jam determination processing, the device management unit 35a executes the processing of S201.

When the device management unit 35a determines in S204 that there are no jam locations of specific jam locations, which have not yet been targeted in this long-term jam determination processing, the device management unit 35a terminates the long-term jam determination processing shown in FIG. 14.

As shown in FIG. 12, when the long-term jam determination processing of S163 ends, the device management unit 35a determines whether or not the device management unit 35a has determined a jam location that is a failure sign warning target in the long-term jam determination processing of S163 (S164).

When the device management unit 35a determines in S164 that the device management unit 35a has not determined a jam location that is a failure sign warning target in the long-term jam determination processing of S163, the device management unit 35a updates the device management information 34d so that the jam location that is the failure sign warning target in the image forming apparatus 20 is not any jam location (S165).

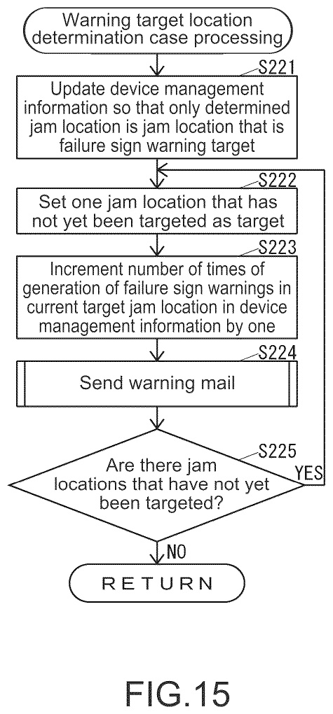

When the device management unit 35a determines in S162 that the device management unit 35a has determined a jam location that is a failure sign warning target in the short-term jam determination processing of S161 or when the device management unit 35a determines in S164 that the device management unit 35a has determined a jam location that is a failure sign warning target in the long-term jam determination processing of S163, the device management unit 35a executes warning target location determination case processing (see FIG. 15) that is processing in a case where the device management unit 35a has determined a jam location that is a failure sign warning target (S166).

FIG. 15 is a flowchart of an example of the warning target location determination case processing shown in FIG. 12.

As shown in FIG. 15, the device management unit 35a updates the device management information 34d so that only the jam location that is the failure sign warning target, which has been determined in the short-term jam determination processing of S161 or the long-term jam determination processing of S163, is the jam location that is the failure sign warning target in the image forming apparatus 20 (S221).

When the processing of S221 ends, the device management unit 35a sets only one jam location of the jam locations that are the failure sign warning targets, which have been determined in the short-term jam determination processing of S161 or the long-term jam determination processing of S163, which has not yet been targeted in this warning target location determination case processing, as a target (S222).

When the processing of S222 ends, the device management unit 35a increments the number of times of generation of failure sign warnings in the current target jam location, which has been associated with the serial number of the image forming apparatus 20 in the device management information 34d, by one (S223).

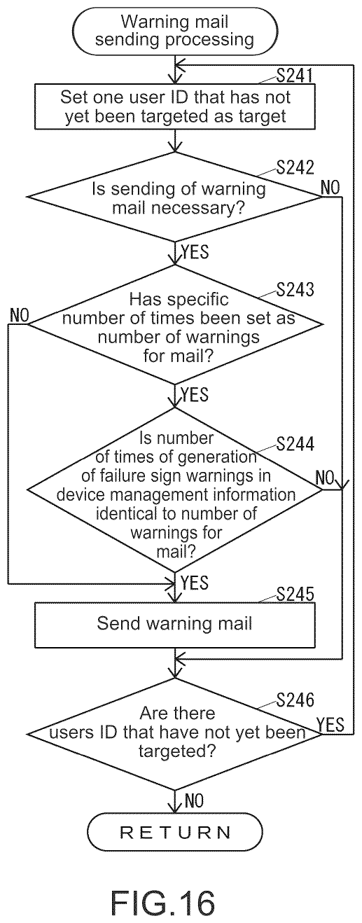

When the processing of S223 ends, the device management unit 35a executes warning mail sending processing (see FIG. 16) that is processing of sending a warning mail (S224).

FIG. 16 is a flowchart of an example of the warning mail sending processing shown in FIG. 15.

As shown in FIG. 16, the device management unit 35a sets only one user ID of all users ID in the user management information 34c associated with the tenant ID associated with the serial number of the image forming apparatus 20 in the device management information 34d, which has not yet been targeted in this warning mail sending processing, as a target (S241).

When the processing of S241 ends, the device management unit 35a determines whether or not sending of the warning mail is necessary on the basis of the warning mail necessity/unnecessity information associated with the current target user ID in the user management information 34c (S242).

When the device management unit 35a determines in S242 that sending of the warning mail is necessary, the device management unit 35a determines whether or not a specific number of times has been set as the number of warnings for mail on the basis of the number of warnings for mail, which has been associated with the current target user ID in the user management information 34c (S243).

When the device management unit 35a determines in S243 that the specific number of times has been set as the number of warnings for mail, the device management unit 35a determines whether or not the number of times of generation of failure sign warnings in the current target jam location, which has been associated with the serial number of the image forming apparatus 20 in the device management information 34d, is identical to the number of warnings for mail, which has been associated with the current target user ID in the user management information 34c (S244).

When the device management unit 35a determines in S243 that the specific number of times has been set as the number of warnings for mail or when the device management unit 35a determines in S244 that the number of times of generation of failure sign warnings in the current target jam location, which has been associated with the serial number of the image forming apparatus 20 in the device management information 34d, is identical to the number of warnings for mail, which has been associated with the current target user ID in the user management information 34c, the device management unit 35a sends a warning mail for the failure sign warnings in the current target jam location to the e-mail address associated with the current target user ID in the user management information 34c (S245).

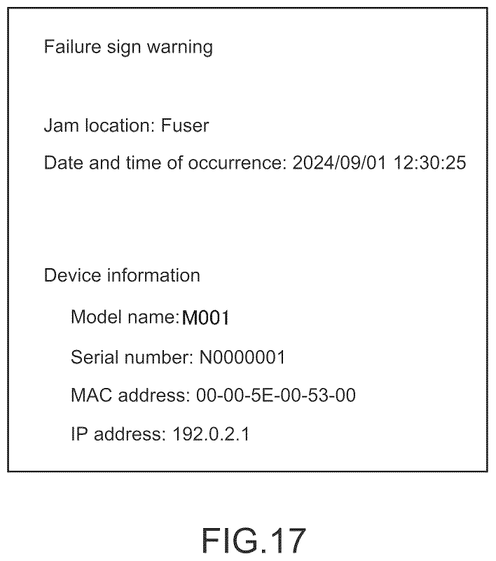

FIG. 17 is a diagram showing an example of the body of the warning mail sent in S245.

As shown in FIG. 17, the body of the warning mail includes the jam location to be indicated by the warning mail and the date and time of occurrence of the latest jam that has occurred in the jam location to be indicated by the warning mail in the image forming apparatus 20. The device management unit 35a determines the date and time of occurrence of the latest jam that has occurred in the jam location to be indicated by the warning mail in the image forming apparatus 20 on the basis of the jam management information 34e.

The body of the warning mail includes the model name, the serial number, the MAC address, and the IP address of the image forming apparatus 20. The device management unit 35a determines the model name, the serial number, the MAC address, and the IP address of the image forming apparatus 20 on the basis of the device management information 34d.

As shown in FIG. 16, when the device management unit 35a determines in S242 that sending of the warning mail is unnecessary, when the device management unit 35a determines in S244 that the number of times of generation of failure sign warnings in the current target jam location, which has been associated with the serial number of the image forming apparatus 20 in the device management information 34d, is not identical to the number of warnings for mail, which has been associated with the current target user ID in the user management information 34c, or when the device management unit 35a executes the processing of S245, the device management unit 35a determines whether or not there are users ID of all users ID in the user management information 34c associated with the tenant ID associated with the serial number of the image forming apparatus 20 in the device management information 34d, which have not yet been targeted in this warning mail sending processing (S246).

When the device management unit 35a determines in S246 that there are users ID of all users ID in the user management information 34c associated with the tenant ID associated with the serial number of the image forming apparatus 20 in the device management information 34d, which have not yet been targeted in this warning mail sending processing, the device management unit 35a executes the processing of S241.

When the device management unit 35a determines in S246 that there is no users ID of all users ID in the user management information 34c associated with the tenant ID associated with the serial number of the image forming apparatus 20 in the device management information 34d, which have not yet been targeted in this warning mail sending processing, the device management unit 35a terminates the execution of the warning mail sending processing shown in FIG. 16.

As shown in FIG. 15, when the warning mail sending processing of S224 ends, the device management unit 35a determines whether or not there are jam locations of the jam locations that are the failure sign warning targets, which have been determined in the short-term jam determination processing of S161 or the long-term jam determination processing of S163, which have not yet been targeted in this warning target location determination case processing (S225).

When the device management unit 35a determines in S225 that there are jam locations of the jam locations that are the failure sign warning targets, which have been determined in the short-term jam determination processing of S161 or the long-term jam determination processing of S163, which have not yet been targeted in this warning target location determination case processing, the device management unit 35a executes the processing of S222.

When the device management unit 35a determines in S225 that there are no jam locations of the jam locations that are the failure sign warning targets, which have been determined in the short-term jam determination processing of S161 or the long-term jam determination processing of S163, which have not yet been targeted in this warning target location determination case processing, the device management unit 35a terminates the warning target location determination case processing shown in FIG. 15.

As shown in FIG. 12, when the processing of S165 ends or when the warning target location determination case processing of S166 ends, the device management unit 35a terminates the execution of the warning generation processing shown in FIG. 12.

As shown in FIG. 11, the device management unit 35a executes the processing of S141 when the warning generation processing of S145 ends.

Next, an operation of the system 10 in a case where the user of the device management system 30 checks the failure sign warning will be described.

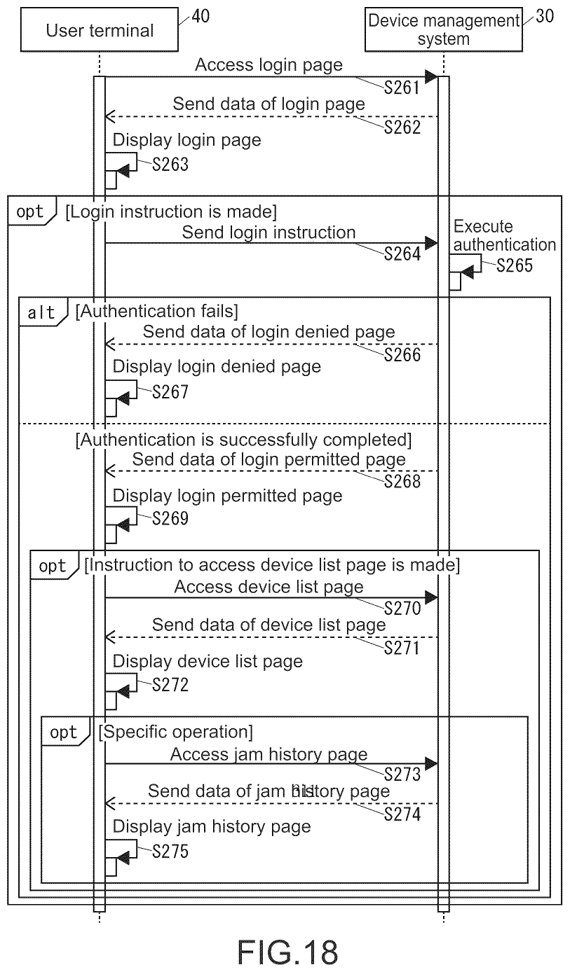

FIG. 18 is a sequence diagram of the operation of the system 10 in a case where the user of the device management system 30 checks the failure sign warning.

The user of the device management system 30 is capable of instructing the user terminal 40 to access a webpage for logging into the device management system 30 (hereinafter, referred to as “login page”), which has been provided by the device management system 30 via the operation unit 41 of the user terminal 40. When the web browser 45a of the user terminal 40 is instructed to access the login page, as shown in FIG. 18, the web browser 45a of the user terminal 40 accesses the login page (S261).

When the device management unit 35a of the device management system 30 receives the access in S261, the device management unit 35a of the device management system 30 sends data of the login page to the web browser 45a of the user terminal 40 (S262).

When the web browser 45a receives the data sent by the device management system 30 in S262, the web browser 45a displays the login page on the display unit 42 on the basis of the received data (S263).

The user of the device management system 30 is capable of instructing to log into the device management system 30 on the login page via the operation unit 41 after inputting the user ID and the password of the user him or herself to the login page displayed in S263 via the operation unit 41 of the user terminal 40. When the web browser 45a is instructed to log into the device management system 30 on the login page, the web browser 45a sends a login instruction including the combination of the user ID and the password input to the login page to the device management system 30 (S264).

When the device management unit 35a of the device management system 30 receives the login instruction sent by the user terminal 40 in S264, the device management unit 35a of the device management system 30 executes the user authentication on the basis of the combination of the user ID and the password included in the received login instruction (S265). In a case where the combination of the user ID and the password included in the login instruction is included in the user management information 34c, the device management unit 35a determines that the user authentication has been successfully completed. On the other hand, in a case where the combination of the user ID and the password included in the login instruction is not included in the user management information 34c, the device management unit 35a determines that the user authentication has failed.

When the device management unit 35a determines that the authentication executed in S265 has failed, the device management unit 35a sends data of a webpage (hereinafter, referred to as “login denied page”) for notifying of the user's login denied to the web browser 45a of the user terminal 40 (S266).

When the web browser 45a receives the data sent by the device management system 30 in S266, the web browser 45a displays the login denied page on the display unit 42 on the basis of the received data (S267).

When the device management unit 35a determines that the authentication executed in S265 has been successfully completed, the device management unit 35a sends data of a webpage (hereinafter, referred to as “login permitted page”) for notifying of the user's login permitted to the web browser 45a of the user terminal 40 (S268).

When the web browser 45a receives the data sent by the device management system 30 in S268, the web browser 45a displays the login permitted page on the display unit 42 on the basis of the received data (S269).

In a case where the user of the device management system 30 has logged into the device management system 30, the user of the device management system 30 is capable of instructing the user terminal 40 to access a webpage (hereinafter, referred to as “device list page”) showing a list of image forming apparatuses belonging to the tenant to which the image forming apparatus 20 belongs via the operation unit 41 of the user terminal 40. When the web browser 45a of the user terminal 40 is instructed to access the device list page, the web browser 45a of the user terminal 40 accesses the device list page (S270).

When the device management unit 35a of the device management system 30 receives the access in S270, the device management unit 35a of the device management system 30 sends data of the device list page to the web browser 45a of the user terminal 40 (S271).

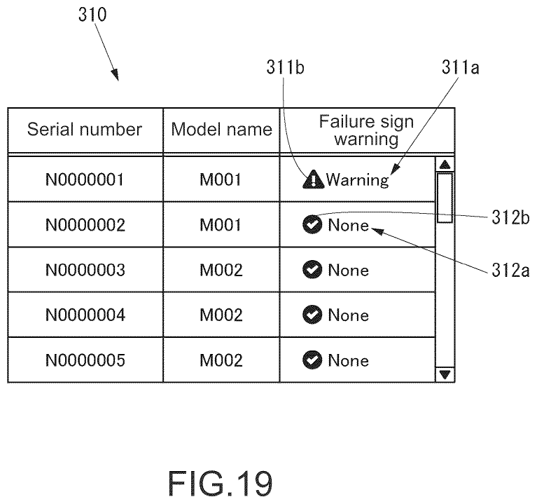

When the web browser 45a receives the data sent by the device management system 30 in S271, the web browser 45a displays a device list page 310 (e.g., see FIG. 19) on the display unit 42 on the basis of the received data (S272).

FIG. 19 is a diagram showing an example of the device list page 310 displayed in S272.

The device list page 310 shown in FIG. 19 includes, for each image forming apparatus, a serial number of the image forming apparatus, a model name of the image forming apparatus, and whether or not a failure sign warning has occurred. In the device list page 310 shown in FIG. 19, a character string 311a, “Warning,” and a mark 311b left next to the character string 311a show that the failure sign warning has occurred. On the other hand, a character string 312a, “None,” and a mark 312b left next to the character string 312a show that no failure sign warning has occurred.

The user of the device management system 30 is capable of pressing at least either the character string 311a, “Warning,” or the mark 311b left next to the character string 311a on the device list page 310 via the operation unit 41 of the user terminal 40. When at least either the character string 311a, “Warning,” or the mark 311b left next to the character string 311a are pressed on the device list page 310, as shown in FIG. 18, the web browser 45a of the user terminal 40 accesses a webpage (hereinafter, referred to as “jam history page”) showing a history of occurrence of jams in an image forming apparatus corresponding to at least either the character string 311a, “Warning,” or the mark 311b left next to the character string 311a, which has been pressed on the device list page 310 (S273).

When the device management unit 35a of the device management system 30 receives the access in S273, the device management unit 35a of the device management system 30 sends data of the jam history page to the web browser 45a of the user terminal 40 (S274).

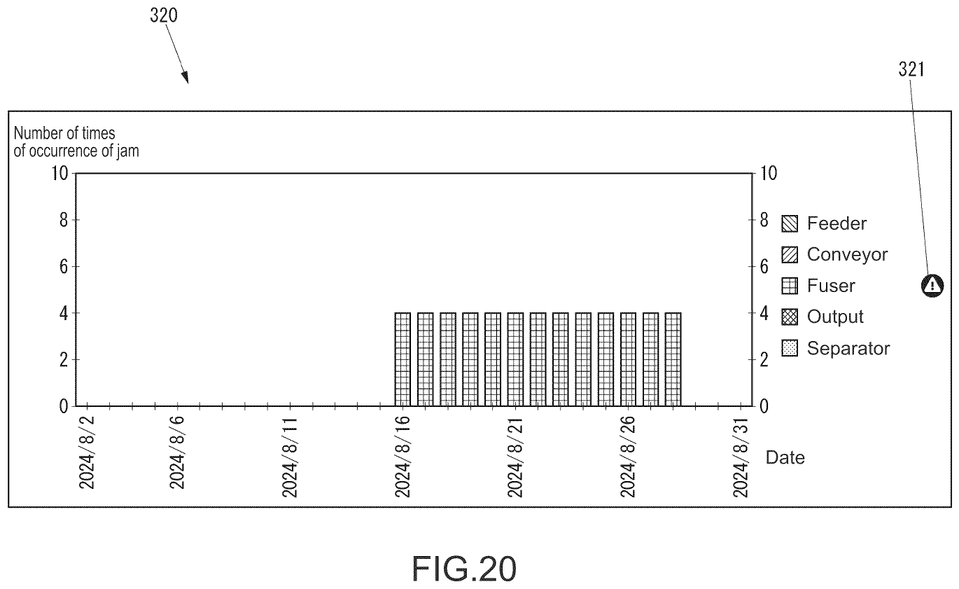

When the web browser 45a receives the data sent by the device management system 30 in S274, the web browser 45a displays a jam history page 320 (see FIG. 20) on the display unit 42 on the basis of the received data (S275).

FIG. 20 is a diagram showing an example of the jam history page 320 displayed in S275.

The jam history page 320 shown in FIG. 20 shows, for each day, the number of times of jams that have occurred in an image forming apparatus corresponding to this jam history page 320. In the jam history page 320 shown in FIG. 20, those within the period of 30 days ago to the previous day are shown as the number of times of jams for each day. In the jam history page 320 shown in FIG. 20, the breakdown is shown for each jam location as the number of times of jams for each day. In the jam history page 320 shown in FIG. 20, a mark 321 indicating the failure sign warning is shown in the jam location that is the failure sign warning target.

As described above, in a case where the device management system 30 executes a warning of a failure sign in the image forming apparatus (S221), the device management system 30 sends a warning mail that is an e-mail for notifying of the warning of the failure sign in the image forming apparatus (S245). Therefore, the device management system 30 is capable of allowing the user to easily recognize the failure sign in the image forming apparatus. A person who receives the warning mail is capable of recognizing the failure sign in the image forming apparatus on the basis of the warning mail, and is capable of determining whether or not it is necessary to dispatch a person in charge for repairing the image forming apparatus on the basis of information obtained by accessing at least either the device list page or the jam history page, for example.

Even in a case where the device management system 30 executes the warning of the failure sign in the image forming apparatus, the device management system 30 does not send the warning mail if sending of the warning mail is set to be unnecessary (NO in S242). Therefore, the device management system 30 is capable of enhancing the convenience.

Even in a case where the device management system 30 executes the warning of the failure sign in the image forming apparatus, the device management system 30 does not send the warning mail if the number of times of generation of warnings in a certain period is not identical to the specific number of times (NO in S244). Therefore, the device management system 30 is capable of reducing the possibility of sending the warning mail of the same contents multiple times.

The device management system 30 executes (S221) the warning of the failure sign in the image forming apparatus in a case of satisfying a first condition (S182 to S184) including a condition that the day on which the number of times of occurrence of the jam in the image forming apparatus is a first number of times, i.e., Na times or more, is included in a first period, i.e., the period of Db days ago to the previous day (YES in S183), in other words, a case where jams have occurred so many times within a relatively short period, and in a case of satisfying a second condition (S202) including a condition that the number of times of occurrence of the jam within a second period longer than the first period, i.e., the period of Da days ago to the previous day, is a second number of times, i.e., Nb times or more (YES in S202), in other words, a case where the jams have occurred many times during a relatively long period. Therefore, the device management system 30 is capable of enhancing the warning accuracy of the failure sign in the image forming apparatus.

In the present embodiment, the device management system 30 warns of the failure sign in the image forming apparatus on the basis of the information regarding the jam in the image forming apparatus. However, the device management system according to the present disclosure may warn of a failure sign in the device on the basis of a matter other than the jam.

In the present embodiment, the device management system 30 manages the image forming apparatuses as devices. However, the device management system according to the present disclosure may manage electronic apparatuses other than the image forming apparatuses as devices.

It should be understood by those skilled in the art that various modifications, combinations, sub-combinations and alterations may occur depending on design requirements and other factors insofar as they are within the scope of the appended claims or the equivalents thereof.

What is claimed is:

1. A device management system, comprising
a device management unit that manages a device, wherein
the device management unit executes a warning of a sign of a failure in the device, and
the device management unit sends a warning mail that is an e-mail for notifying of the warning in a case where the device management unit executes the warning.

2. The device management system according to claim 1, wherein
the device management unit does not send the warning mail if sending of the warning mail is set to be unnecessary even in a case where the device management unit executes the warning.

3. The device management system according to claim 1, wherein
the device management unit does not send the warning mail if the number of times of generation of the warning in a certain period is not identical to a specific number of times even in a case where the device management unit executes the warning.

4. The device management system according to claim 1, wherein
the device is an image forming apparatus, and
the device management unit
executes the warning in a case of satisfying a first condition including a condition that a day on which the number of times of occurrence of a jam in the image forming apparatus is greater than or equal to a first number of times is included in the first period, and
executes the warning in a case of satisfying a second condition including a condition that a day on which the number of times of occurrence of the jam is greater than or equal to a second number of times is included in a second period longer than the first period.

5. A device management program that causes a computer to operate as a device management unit that manages a device, wherein
the device management unit executes a warning of a sign of a failure in the device, and
the device management unit sends a warning mail that is an e-mail for notifying of the warning in a case where the device management unit executes the warning.
